(19) United States
(12) Patent Application Publication
(10) Pub. No.: US 2013/0115086 A1
(43) Pub. Date: May 9, 2013

(54) VERTICAL AXIS WIND TURBINE

(71) Applicant: Steven C. Hench, Annapolis, MD (US)

(72) Inventor: Steven C. Hench, Annapolis, MD (US)

(21) Appl. No.: 13/667,826

(22) Filed: Nov. 2, 2012

Related U.S. Application Data
(60) Provisional application No. 61/556,127, filed on Nov. 4, 2011.

(51) Int. Cl. F03D 3/06

(52) U.S. Cl. 416/132 A

(57) ABSTRACT

A vertical axis wind turbine may comprise a plurality of sail members arranged about a substantially vertical axis of rotation, the sail members having first ends converging to and rotatably supported at a substantially single point, and second ends coupled to a base member substantially aligned with the axis of rotation. A vertical axis wind turbine system may comprise a plurality of sail members having first ends converging to a single point along an axis of rotation, second ends coupled with a base member, and a generator configured to convert kinetic energy from the rotating plurality of sail members and the base member into electrical energy. An array of vertical axis wind turbines may comprise a plurality of vertical axis wind turbines arranged in a predetermined configuration and coupled through common support structure.

### CROSS-REFERENCE TO RELATED APPLICATIONS

This application claims priority to U.S. Provisional Application No. 61/556,127, entitled VERTICAL AXIS WIND TURBINE, filed Nov. 4, 2011, which is hereby incorporated by reference for all purposes.

### FIELD OF THE INVENTION

The present disclosure generally relates to wind turbines, and more particularly to a wind turbine having sail members rotating about a vertically-oriented center of rotation and converging to a single point.

### BACKGROUND

Wind turbines convert the kinetic energy of wind into useful electrical energy. Most wind turbines use spinning lift or drag type elements to extract energy from the wind, and transfer that energy through a rotating shaft to power a mechanical or electro-mechanical generator. A particular advantage of vertically-oriented turbines is that their direction of rotation is always orthogonal to the wind vector, eliminating the need to orient them based on wind direction.

There are several types of vertical axis wind turbine designs in existence. One type, the Savonius wind turbine, features multiple scoops rotating on a central vertical shaft. Each scoop captures air inside as it rotates into alignment with the wind direction, propelling the scoop forward. However, as the scoop continues its rotation back against the wind, it is forced to displace the oncoming air, resulting in relatively high drag. For this reason, Savonius wind turbines are relatively inefficient at converting wind energy into electricity. Another design, known as a Darrieus wind turbine, uses semi-oval shaped vertical blades that rotate on a central vertical shaft. Each blade features symmetrical airfoil cross sections set at zero angle of attack and rigging angle relative to the center shaft. These blades create a lift vector in the direction of rotation, but only at certain azimuths as dictated by wind direction. While they are generally more efficient than Savonius turbines, Darrieus wind turbines have great difficulty self-starting, even with high wind speeds, and are susceptible to structural damage and safety issues in extreme wind conditions. Additionally, the blades generate varying power around the rotational azimuth due, creating a pulsating torque output. A third type of vertical axis wind turbine design is the Gorlov wind turbine. The Gorlov evolved from the Darrieus design, but uses twisted helical shaped blades to create rotational thrust. By distributing the airfoils at varying angles of attack, the Gorlov design generates smoother torque throughout the azimuth, instead of the pulsing characteristic of the Darrieus. This leads to reduced vibrations, noise, and structural stresses. Despite its advantages, the Gorlov requires precision manufacturing, assembly, balancing, and tuning, and relies on a large amount of structure for support.

### SUMMARY

The present disclosure is directed to a vertical axis wind turbine apparatus that may comprise a plurality of sail members arranged about a substantially vertical axis of rotation, and a base member in substantial alignment with the axis of rotation, wherein first ends of the plurality of sail members converge to and are rotatably supported at a substantially single point along the axis of rotation, and second ends of the plurality of sail members are coupled to the base member.

In various embodiments, one or more of the plurality of sail members may comprise a rigid or semi-rigid structure. In an embodiment, the structure may be configured to define a predetermined shape to the corresponding sail member.

In an embodiment, one or more of the plurality of sail, members may releasably couple with the base member, In an embodiment, the base member may comprise a disk shape. In another embodiment, the base member may comprise multiple frame members arranged in a substantially common plane. In yet another embodiment, the base member may be configured to provide for imparting one or more predetermined shapes to one or more of the plurality of sail members. In still another embodiment, the base member may comprise coupling mechanisms arranged in one or more predetermined shapes.

In an embodiment, the base member may be at least partially collapsible. In another embodiment, the plurality of sail members may couple with the base member such that they substantially meet at a center point. In yet another embodiment, the plurality of sail members may couple with the base member such that they overlap near the axis of rotation.

In an embodiment, apparatus may comprise a top member configured to couple the second ends of the plurality of sail members together at the substantially single point. In another embodiment, the top member may be rotatably coupled to supporting structure.

In an embodiment, apparatus may comprise a generator coupled with the base member. In another embodiment, the base member and the generator may be coupled by a friction wheel.

In another aspect, the present disclosure is directed to a vertical axis wind turbine system that may comprise a plurality of sail members arranged about an axis of rotation, the plurality of sail members having first ends converging to a single point along the axis of rotation; a base member in substantial alignment with the axis of rotation configured to couple with second ends of the plurality of sail members, wherein the plurality of sail members and the base member are configured to rotate about the axis of rotation in response to fluid forces acting thereon; and a generator configured to convert kinetic energy from the rotating plurality of sail members and the base member into electrical energy.

In yet another aspect, the present disclosure is directed to an array of vertical axis wind turbines that may comprise a plurality of vertical axis wind turbines, each comprising a plurality of sail members, each having a first end and a second end, the plurality of sail members being arranged about a substantially vertical axis of rotation, and a base member oriented substantially perpendicular to the axis of rotation, wherein the first end of each of the plurality of sail members converges to and is rotatably supported at a substantially single point, and the second end of each of the plurality of sail members is coupled to the base member, the plurality of vertical axis wind turbines arranged in a predetermined configuration and coupled through common support structure.

In an embodiment, the predetermined configuration may comprise a hub-type configuration. In another embodiment, the predetermined configuration may comprise a string type configuration. In yet another embodiment, the plurality of vertical axis wind turbines may be coupled through a common electrical grid.

### BRIEF DESCRIPTION OF THE DRAWINGS

For a more complete understanding of this disclosure, reference is now made to the following description, taken in conjunction with the accompanying drawings, in which:

FIG. 1 depicts a perspective view of a vertical axis wind turbine according to an embodiment of the present disclosure;

FIG. 2 depicts a side view of possible perimeter shapes of a sail member used in a vertical axis wind turbine according to an embodiment of the present disclosure;

FIG. 3A depicts a top view of a sail member configuration used in a vertical axis wind turbine according to an embodiment of the present disclosure;

FIG. 3B depicts a partial perspective view of a sail member configuration used in a vertical axis wind turbine according to an embodiment of the present disclosure;

FIG. 3C depicts a top view of possible trim shapes of sail members used in a vertical axis wind turbine according to an embodiment of the present disclosure;

FIG. 3D depicts a top view of a straight frame member for achieving a trim shape of sail members used in a vertical axis wind turbine according to an embodiment of the present disclosure;

FIG. 3E depicts a top view of a curved frame member for achieving a trim shape of sail members used in a vertical axis wind turbine according to an embodiment of the present disclosure;

FIG. 4A depicts a lace attachment mechanism for attaching sail members to a base in a vertical axis wind turbine according to an embodiment of the present disclosure;

FIG. 4B depicts a clip attachment mechanism for attaching sail members to a base in a vertical axis wind turbine according to an embodiment of the present disclosure;

FIG. 4C depicts possible “flow over” properties of captured wind in an “overlapping” sail embodiment of the present disclosure;

FIG. 5 depicts a perspective view of a Savonius wind turbine;

FIG. 6 depicts a perspective view of a possible top member according to an embodiment of the present disclosure;

FIG. 7A depicts a partial perspective view of a possible cable mechanism for transferring energy to a generator according to an embodiment of the present disclosure;

FIG. 7B depicts a top view of a possible friction wheel mechanism for transferring energy to a generator according to an embodiment of the present disclosure;

FIG. 7C depicts a side view of a possible friction wheel mechanism for transferring energy to a generator according to an embodiment of the present disclosure;

FIG. 8A depicts a top view of a possible hub-type arrangement of multiple vertical axis wind turbines according to an embodiment of the present disclosure;

FIG. 8B depicts a perspective view of a possible hub-type arrangement of multiple vertical axis wind turbines according to an embodiment of the present disclosure;

FIG. 8C depicts a top view of a possible string-type arrangement of multiple vertical axis wind turbines according to an embodiment of the present disclosure;

FIG. 8D depicts a perspective view of a possible string-type arrangement of multiple vertical axis wind turbines according to an embodiment of the present disclosure;

### DETAILED DESCRIPTION

An apparatus according to the present disclosure is a wind turbine that houses components that facilitate harnessing the kinetic energy of wind and convert that energy into electrical energy. As detailed herein, components within the wind turbine comprise multiple sail members rotating about a vertically-oriented center of rotation as they spin under the influence of wind. The rotating sail members, in turn, may drive a generator mechanism. In one embodiment, the generated energy may be stored or used locally, or transferred by conductors for storage or use at another location. In another embodiment, an array of wind turbines is employed through a common mechanical hub or electrical grid.

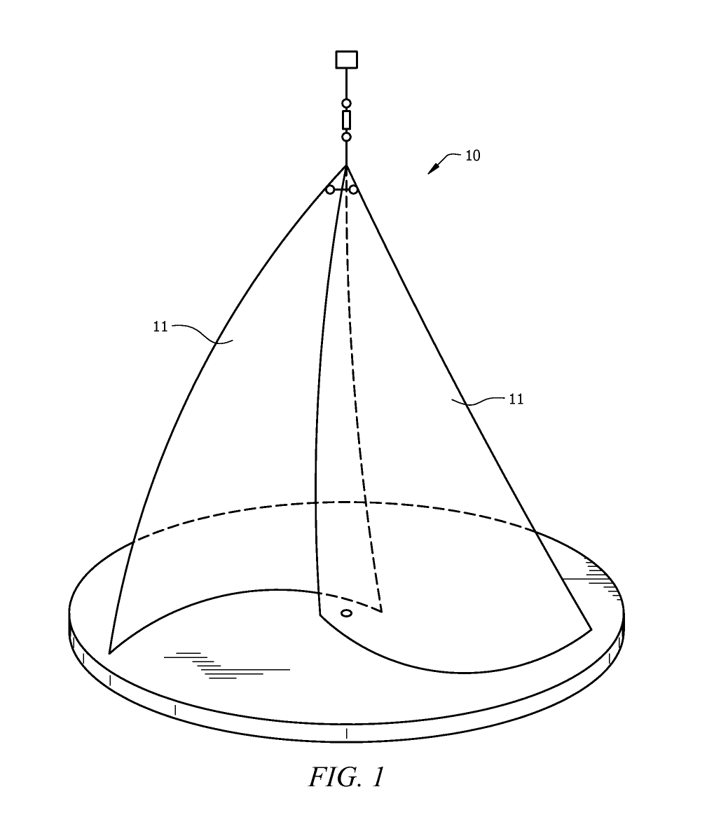

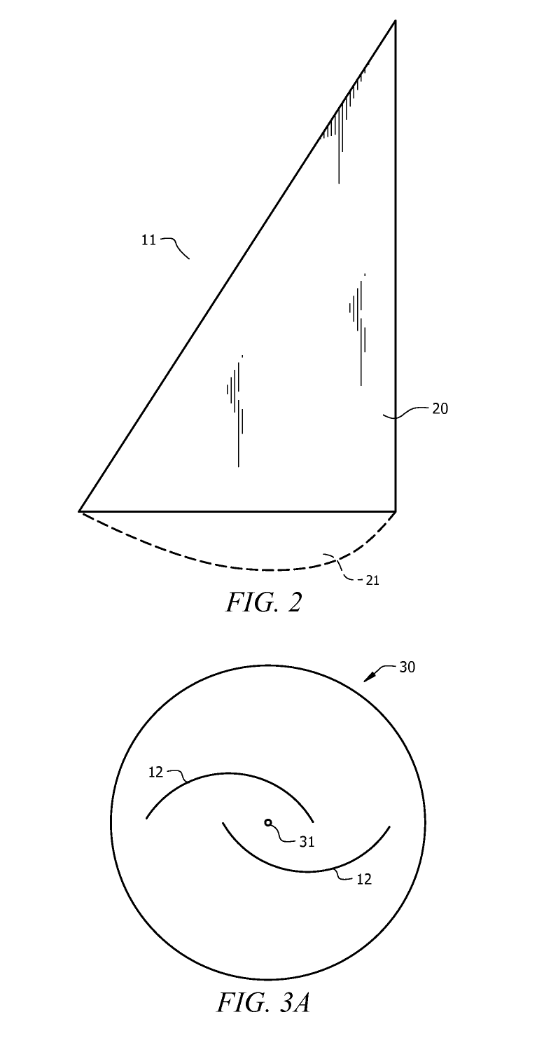

As seen in FIG. 1, wind turbine 10 is characterized by one or more sail members ii supported in tension from top and bottom. Sail members 11 may consist of a multitude of geometric shapes—in one embodiment, sail members 11 may be of identical shape and dimensions. One embodiment utilizes triangular shaped 20 or oblique cone shaped 21 sail members, illustrated in FIG. 2, as these shapes offer significant wind capture surface area and converge to a point at the top end. Preferably, the sail members are comprised of durable, lightweight, inexpensive materials having relatively high strength. Examples of such materials include, but are not limited to, fabric, nylon, canvas, pliable plastics, rigid plastics, tarpaulin, fiberglass, or carbon fiber. Other suitable materials will be readily apparent to those skilled in the art. Portions or entirety of each sail member may include a rigid or semi-rigid structure to enhance strength or define a specific shape or curvature to the sail member for optimal capture of kinetic wind energy. For example, in one embodiment, one or more strips of semi-rigid material, sometimes referred to as battens, may be used to support one or more portions of sail members 11 to help maintain a desired shape of sail members 11. Similarly, those of ordinary skill in the art will recognize that other techniques used in the field of sailing to improve aerodynamic performance of a sail may be applied to sail members 11 in a vertical axis wind turbine according to the present disclosure.

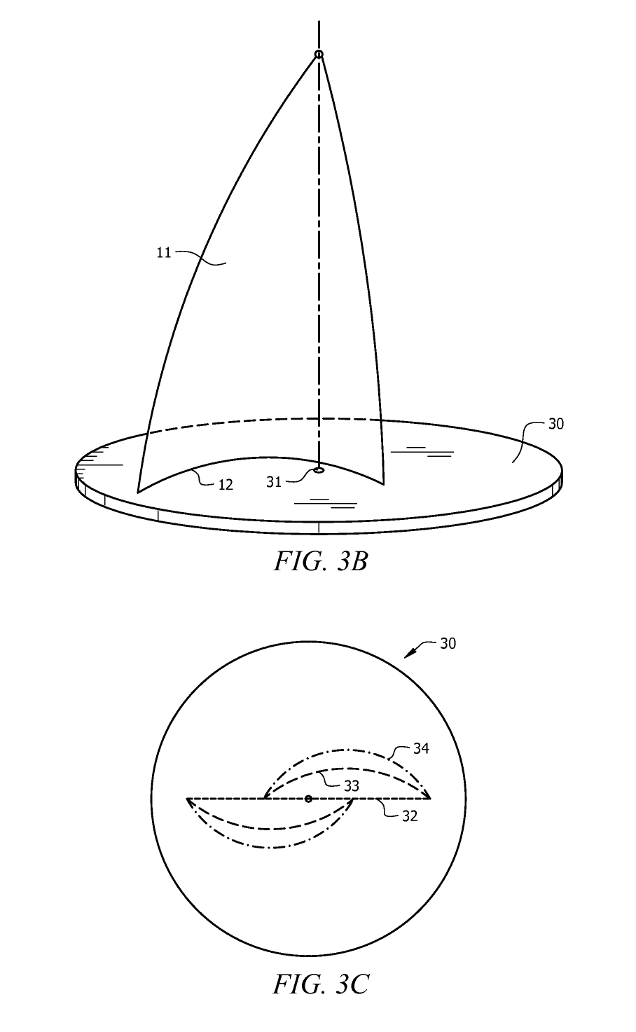

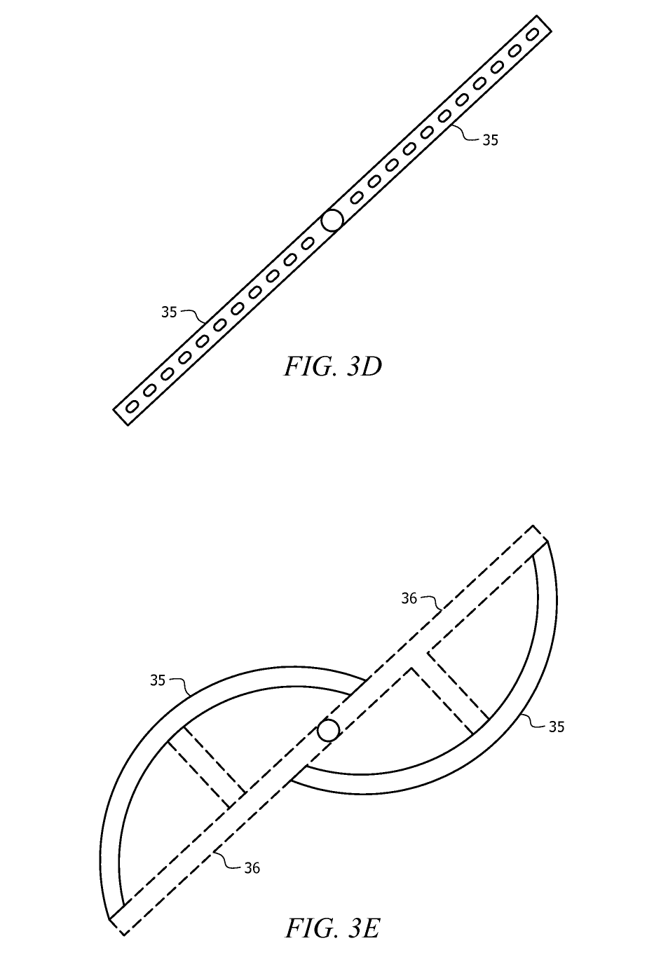

Referring to FIGS. 3A and 3B, wind turbine 10 is further characterized by a base member 30 to which the base end 12 of each sail member connects. Base member is comprised of strong, lightweight materials, and has a symmetric distribution of mass radially around centerpoint 31 to ensure proper balancing as it rotates about a central vertical axis. Preferably, base member is constructed to collapse or disassemble for quick and easy transport. One skilled in the art will recognize that the particular construction of base member is not limited by the following embodiments, though each may be understood to provide their respective advantages and disadvantages.

In one embodiment, base member 30 comprises a disk with radius equal to or greater than base dimension 12 of sail members. Disk may be solid, or comprised of a circular frame with an open center. Said circular frame may further be sheathed with a material to render an effectively solid disk if desired. A solid disk may help capture, or “hold in” wind at the base, improving efficiency of the wind turbine. Mechanisms for attaching sail members to such a base may be distributed throughout the disk, and may be arranged so as to impart a specific shape into the sail members to optimize wind energy capture in varying wind conditions as in FIG. 3C. For example, “cupping” the sail members may assist capturing more wind energy in low velocity wind conditions, whereas tauter, flatter sail configurations may improve performance in higher velocity winds. The illustrated embodiment shows multiple shape options that are variable by the user. For example, the “dashed” pattern 32 could be used for a straight shape, the “dotted” pattern 33 used as a moderately cupped shape, and the “dot-dash” pattern 34 used for a heavily cupped shape. Of course, one of ordinary skill in the art could use any desirable shape option depending on the desired application and the atmospheric conditions.

In another embodiment, base member 30 is a rigid flame comprising multiple identically shaped frame members 35 arranged radially around a central vertical axis in the same axial plane, and having equal spacing between frame members. Symmetric arrangement helps to achieve proper balancing as wind turbine rotates. Frame members should extend a distance equal to or longer than length of base dimension of sail members. Frame members may be straight as shown in FIG. 3D or curved as in FIG. 3E to impart a desired aerodynamic shape to the sail members as discussed in the previous embodiment. If curved, frame members should be arranged in identical orientation as viewed by travelling in a circumferential direction around the central vertical axis. Curved frame members may require additional support structure 36, a possible embodiment of which is shown via dotted lines in FIG. 3E.

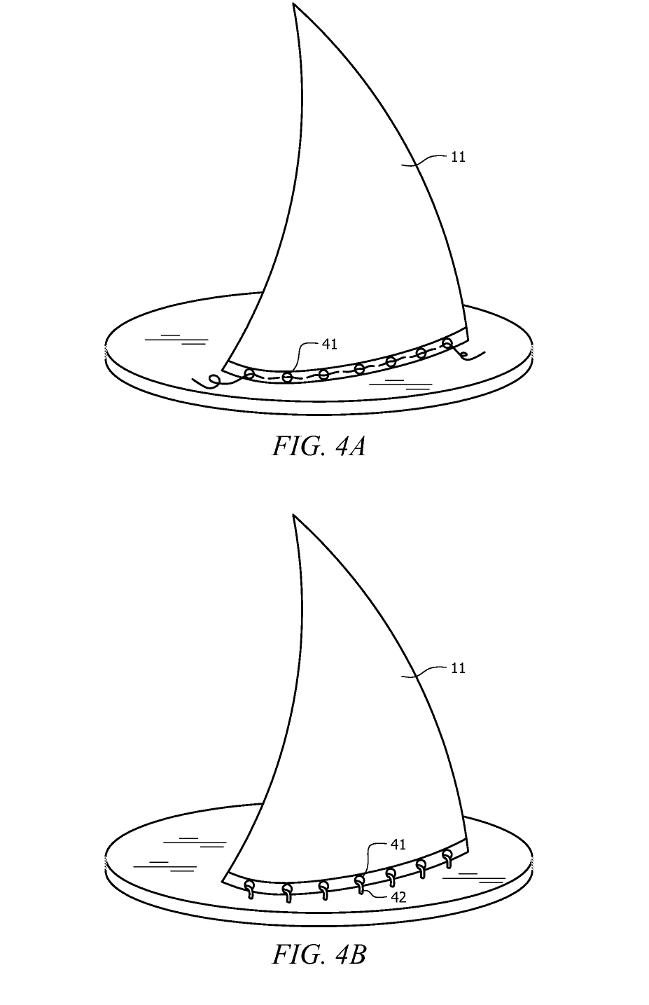

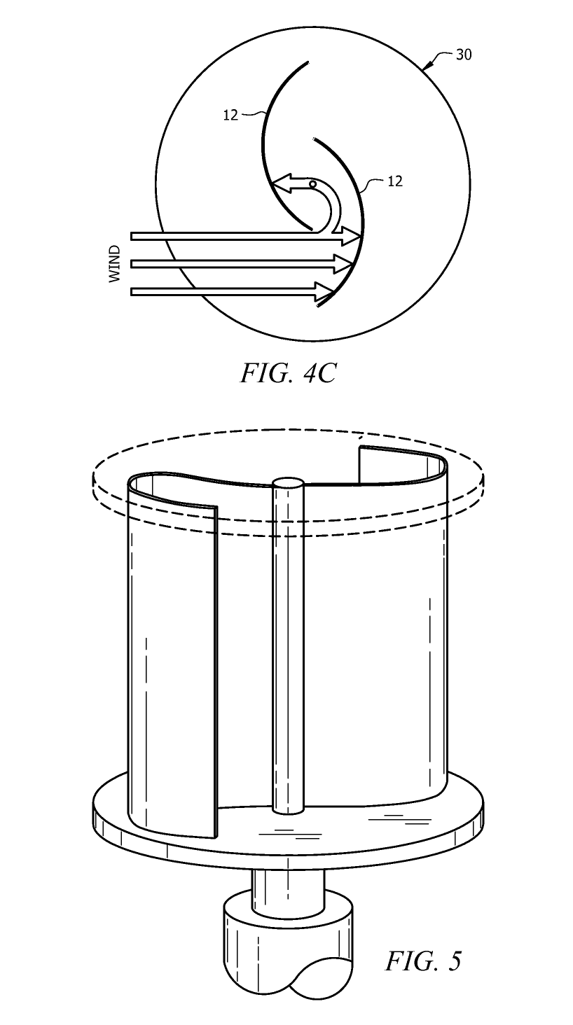

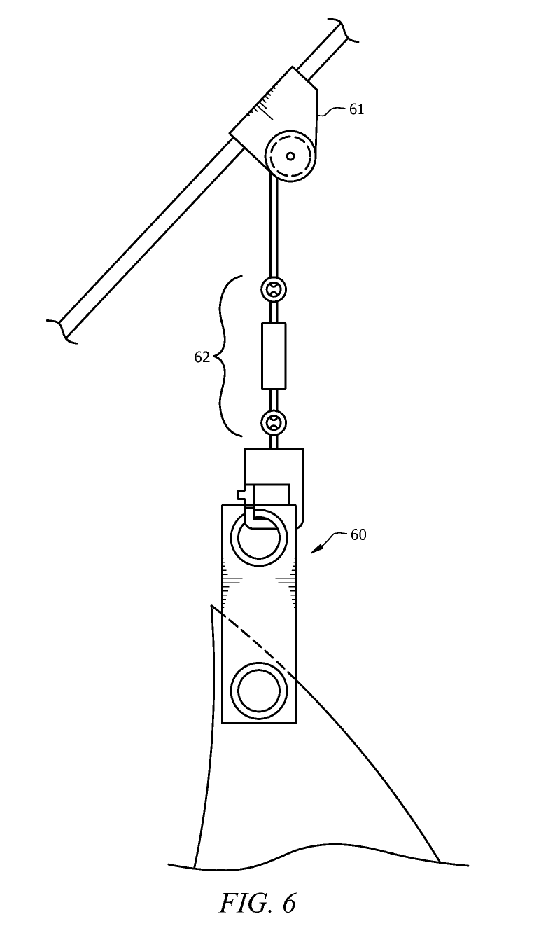

Sail members may connect to base member using a variety of attachment mechanisms such as laces, stitching, straps, hooks, clips, carabineers, glue, etc. In one embodiment, base ends 12 of sail members 11 might feature eyelets 41 or other attachment structure to aid connection with attachment mechanisms like laces or clips, as embodied in FIGS. 4A and 4B respectively. A releasable connection is preferred for ease of maintenance, replacement of sail members, and transportability. Sail members 11 should be oriented in a single direction as viewed by travelling in a circumferential direction around the central vertical axis of rotation. Additionally, sail members 11 may connect to the base member such that they meet at centerpoint 31, or “overlap” some distance. Overlapping the sail members near the center of rotation allows a portion of the wind captured by one sail member to “flow over” into an opposite sail member as shown in FIG. 4C, increasing the efficiency of the turbine by reducing stagnation losses at certain rotational stations and redirecting more air to power the sail members in the direction of rotation (counterclockwise in FIG. 4C). Traditional Savonius wind turbine members connect at the center of rotation rather than overlapping, as shown in FIG. 5.

Wind turbine 10 is further characterized by a top member 60. Top member 60 connects the top of each sail member 11 together at a single point of convergence using simple attachment mechanisms like straps, clips, a ring, etc, perhaps aided by metallic eyelets built into the top end of the sail members. Top member 60 is rotatably connected at an opposite end to a support 61 above the center of rotation using a swivel bearing 62 or similar mechanisms. This configuration requires the wind turbine to use only one base member. Many turbines, such as the Savonius turbine of FIG. 5, utilize base members of significant diameter at each end, making them prone to rotational instability due to even minor imbalances in the system. As such, they require additional tuning, maintenance, and cost to remain operational and safe. By converging each sail member to a single point at one end, the need for a second base member is eliminated, thus alleviating some of these performance, safety, tuning, and maintenance issues, as well as the associated costs. Reduced complexity also enables less sophisticated users to set up and use the wind turbine. Additionally, this configuration requires less material, reducing weight and cost of the apparatus. Any loss of wind capture incurred by the reduced surface area of tapered, triangular shaped sail members may be compensated for by increasing the vertical length or base length of the sail members.

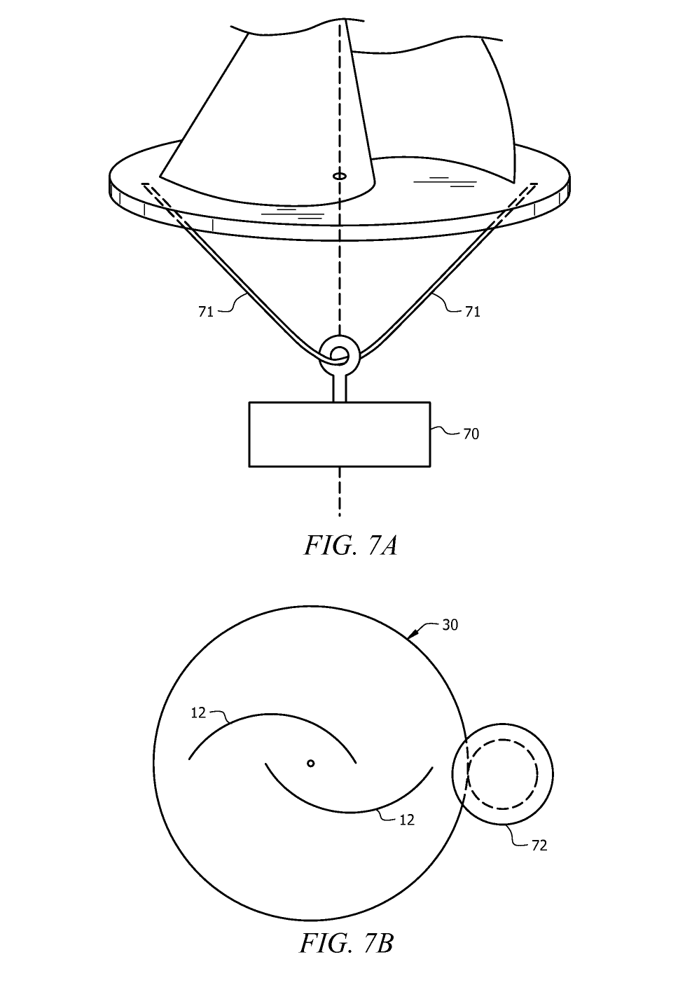

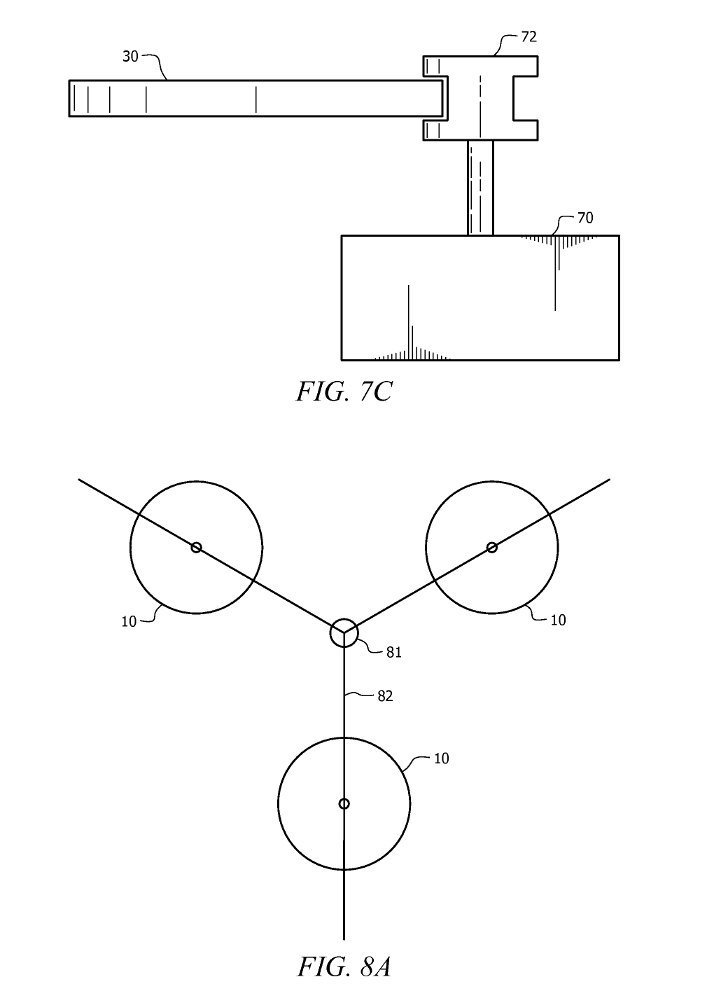

In one embodiment, wind turbine 10 is further characterized by a generator mechanism 70 in mechanical contact with base member 30. Kinetic wind energy is captured by the sail members 11 and ultimately transferred to the generator mechanism 70 via the base member 30 for conversion into electrical energy. One skilled in the art would recognize that several types of connections and generator mechanisms might be used. One embodiment uses cables 71 or similar mechanisms attached to base member 30 to deliver the captured wind energy to the generator mechanism 70, as illustrated in FIG. 7A. Cables 71 are attached to bottom or rim of base member 30 and connect to generator mechanism 70 situated below. As base member 30 spins, cables 71 turn a mechanical input in generator mechanism. Another embodiment, illustrated by top view FIG. 7B and side view FIG. 7C, utilizes a friction wheel 72 in mechanical contact with base member 30 and generator mechanism 70. As base member 30 spins under wind power, friction wheel 72 is rotated, delivering mechanical energy directly into generator mechanism 70. Diameters of base member 30, friction wheel 72, and any associated gearing should be optimized for efficient energy transfer.

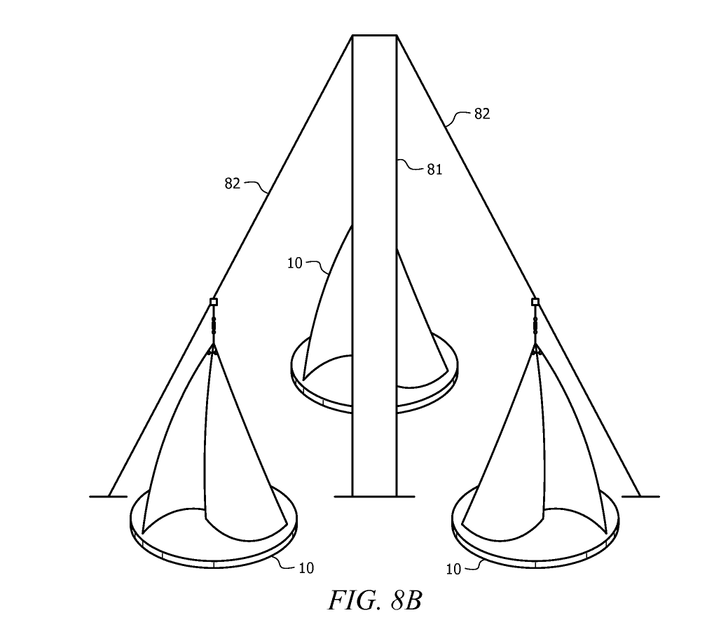

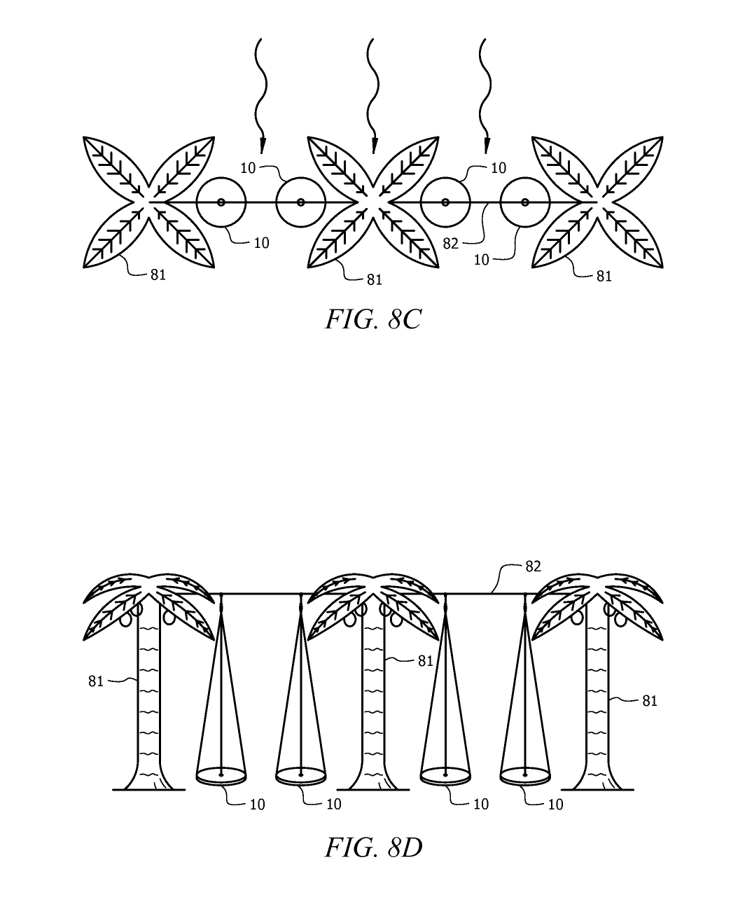

Multiple wind turbines may be combined to increase net power output. For example, multiple wind turbines may share a hub-type configuration characterized by common vertical support, as shown in top view FIG. 8A and side view FIG. 8B. In one embodiment, a vertical support 81 extends vertically from the ground or base structure and guy wires 82 or similar supports extend from top of vertical support 81 to ground or base structure. The vertical support 81 supports the guy wires 82, and the guy wires 82 provide the vertical support for the wind turbine apparatus 10. By way of example but not limitation, this arrangement may prove particularly useful to generate electrical power on the deck of a sailboat. In another embodiment, illustrated by top view in FIG. 8C and side view FIG. 8D, guy wires 82 extend horizontally between multiple vertical supports 81 (shown as palm trees here), enabling the arrangement of a “string” of two or more wind turbines according to the present disclosure that could be set up over a longer distance. This “string” could he set up perpendicular to prevailing winds so as to capture undisturbed freestream wind in each wind turbine. One skilled in the art would recognize that the wind turbine apparatus might easily be arranged with others in a multitude of combinations, with each combination customizable to local spatial constraints and atmospheric conditions.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A vertical axis wind turbine apparatus comprising:
a plurality of sail members arranged about a substantially vertical axis of rotation; and
a base member in substantial alignment with the axis of rotation;
wherein first ends of the plurality of sail members converge to and are rotatably supported at a substantially single point along the axis of rotation, and second ends of the plurality of sail members are coupled to the base member.

2. The apparatus of claim 1, wherein one or more of the plurality of sad members comprises a rigid or semi-rigid structure.

3. The apparatus of claim 2, wherein the structure is configured to define a predetermined shape to the corresponding sail member.

4. The apparatus of claim 1, wherein one or more of the plurality of sail members releasably couple with the base member.

5. The apparatus of claim 1, wherein the base member comprises a disk shape.

6. The apparatus of claim 1, wherein the base member comprises multiple frame members arranged in a substantially common plane.

7. The apparatus of claim 1, wherein the base member is configured to provide for imparting one or more predetermined shapes to one or more of the plurality of sail members.

8. The apparatus of claim 1, wherein the base member comprises coupling mechanisms arranged in one or more predetermined shapes.

9. The apparatus of claim 1, wherein the base member is at least partially collapsible.

10. The apparatus of claim 1, wherein the plurality of sail members couple with the base member such that they substantially meet at a center point.

11. The apparatus of claim 1, wherein the plurality of sail members couple with the base member such that they overlap near the axis of rotation.

12. The apparatus of claim 1, comprising a top member configured to couple the second ends of the plurality of sail members together at the substantially single point.

13. The apparatus of claim 12, wherein the top member is rotatably coupled to supporting structure.

14. The apparatus of claim 1, comprising a generator coupled with the base member.

15. The apparatus of claim 14, wherein the base member and the generator are coupled by a friction wheel.

16. A vertical axis wind turbine system comprising:
a plurality of sail members arranged about an axis of rotation, the plurality of sail members having first ends converging to a single point along the axis of rotation;
a base member in substantial alignment with the axis of rotation configured to couple with second ends of the plurality of sail members;
wherein the plurality of sail members and the base member are configured to rotate about the axis of rotation in response to fluid forces acting thereon; and
a generator configured to convert kinetic energy from the rotating plurality of sail members and the base member into electrical energy.

17. An array of vertical axis wind turbines comprising:
a plurality of vertical axis wind turbines, each comprising:
a plurality of sail members, each having a first end and a second end, the plurality of sail members being arranged about a substantially vertical axis of rotation; and
a base member oriented substantially perpendicular to the axis of rotation;
wherein the first end of each of the plurality of sail members converges to and is rotatably supported at a substantially single point, and the second end of each of the plurality of sail members is coupled to the base member;
the plurality of vertical axis wind turbines arranged in a predetermined configuration and coupled through common support structure.

18. The array of claim 17, the predetermined configuration comprising a hub-type configuration.

19. The array of claim 17, the predetermined configuration comprising a string-type configuration.

20. The army of claim 17, the plurality of vertical axis wind turbines coupled through a common electrical grid.
